(19) United States
(12) Patent Application Publication
(10) Pub. No.: US 2026/0304345 A1
(43) Pub. Date: Oct. 1, 2026

(54) METHODS AND APPARATUSES FOR USER PLANE-BASED SERVICE LEVEL SIGNALING CONTROL FOR NEXT GENERATION NETWORK

(71) Applicant: InterDigital Patent Holdings, Inc., Wilmington, DE (US)

(72) Inventors: Jung Je Son, Warrington, PA (US); Anuj Sethi, Ottawa (CA); Samir Ferdi, Kirkland (CA); Guanzhou Wang, Brossard (CA)

(73) Assignee: InterDigital Patent Holdings, Inc., Wilmington, DE (US)

(21) Appl. No.: 19/092,821

(22) Filed: Mar. 27, 2025

(51) Int. Cl. H04W 60/04; H04W 8/22; H04W 12/06; H04W 68/02; H04W 84/04

(52) U.S. Cl. CPC H04W 60/04; H04W 8/22; H04W 12/06; H04W 68/02; H04W 84/042

(57) ABSTRACT

Methods implemented by a WTRU are disclosed using service level signaling control via a user plane (UP) may include sending, to the network, a registration request with a list of services for authorization and configuration and receiving a registration response with list of authorized services and indication whether the establishment of a dedicated service configuration PDU session is pending or not. Based on the indication, if needed, a WTRU may send a PDU session setup request for a service configuration. The WTRU receives a PDU session setup response for service configuration which includes information for accessing a configuration server for configuration or configuration updates for the authorized services. In an example, the WTRU may access the configuration server for configuration update of the authorized services using security credentials received from the network. Additional embodiments are disclosed.

### BACKGROUND

As mobile networks evolve, there have been significant efforts to enable vertical services of a mobile network as value added service for mobile operators. Initially, Internet of Things (IoT) service enablement using low cost mobile terminals were developed and later, value added services have been expanded using more functionality in mobile terminals such as proximity services (ProSe), ranging, unmanned aerial vehicles (UAVs), etc. As more vertical services are enabled over the 5G network, it becomes more important how mobile networks control vertical service enablement efficiently. Service enablement includes how user equipment (UE) are authorized and configured with parameters for vertical services. Until recently, parameter configurations for each service has been handled separately via the non-access stratum (NAS) (i.e., control plane (CP) signaling) or via the user plane (UP) connection in 5G. It will be beneficial to deploy a general functionality for configuration and control for service enablement assuming more vertical services are deployed as the mobile system evolves.

In the 5G System (5GS), a UE configuration update procedure over NAS connection (i.e. CP signaling via the UE and access and mobility management function (AMF) connection) are designed to serve this purpose (e.g. for configuring ProSe service, Ranging service, etc.). However, it will not be extensible to use the control plane for vertical service enablement because NAS signaling can be easily overloaded as a single contact point between the UE and mobile network, i.e. AMF is the NAS control plane signaling anchor at the 5G core network (5GC). Additionally, for roaming scenarios, some of services should best be configured directly by the home network and other services may be best configured by visited network. Therefore, supporting a roaming situation properly will be also important requirement for service enabling.

When a UE, interchangeably referred to herein as a wireless transmit/receive unit (WTRU), is configured for many vertical services over a mobile network, solutions are needed to how to efficiently deploy access and obtain configurations for different services, preferably, regardless of a WTRU's status (e.g. roaming, etc.) and taking into consideration the WTRU's state (i.e. idle vs connected mode).

### SUMMARY

One or more of the foregoing issues may be addressed in various aspects of this disclosure which provide service configuration and relevant parameters over a protocol data unit (PDU) session dedicated for the service configuration. Over the service configuration PDU session, a WTRU may access a service agent which is responsible for configuration of parameters for the authorized services.

In a first aspect, a method implemented by a WTRU using service level signaling control via a user plane (UP) may include sending, to the network, a registration request with a list of services for authorization and configuration and receiving a registration response with list of authorized services and indication whether the establishment of a PDU session is pending. Based on the indication, if needed, a WTRU may send a PDU session setup request for a service configuration. The WTRU receives a PDU session setup response for service configuration which includes information for accessing a configuration server for the authorized services. In an example, the WTRU may access the configuration server for configuration update of the authorized services using security credentials received from NW. From an AMF perspective, the AMF may receive the registration request from the WTRU with the list of services for authorization and configuration and authorize the registration request and the requested service based on the subscription data of the WTRU retrieved, for example from unified data management (UDM). The AMF may send a registration response to the WTRU with a list of one more authorized services. In an example, the AMF may initiate a request for PDU session setup for the service configuration with the authorized services and receive a response for PDU session setup that includes parameters for an established PDU session (e.g. QoS flows) and information for accessing a configuration server for the authorized services. In an example, the AMF sends a NAS signalling message to the WTRU which includes the PDU session setup response with information for accessing configuration server for the authorized services.

In a second aspect, a method implemented by a WTRU for handling of service level signaling while in idle mode. In an example, the WTRU may receive a paging for a service configuration update including a paging code for a service configuration indication, for service information, or for WTRU information. In response to the paging, the WTRU may send a request for a state change to the connected mode/state. The WTRU may then receive a PDU session activation with indication of a service configuration update that may be needed with relevant service information. The WTRU may determine if the service configuration update is needed based on configuration version number per service. If needed, the WTRU may access a configuration server and receive the updated configuration information for the service(s) that needs configuration updating. Additional aspects, advantages, features and may become apparent from the detailed embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating a simplified 5GS architecture;

FIG. 3 is a block diagram illustrating a control plane (CP) stack between a WTRU and an access and mobility management function (AMF);

FIG. 4 is a network message diagram illustrating a method for providing service level control signaling via a user plane (UP) according to one example embodiment;

FIG. 5 is a network message diagram illustrating a first option for idle mode handling of service level signal control via a policy and charging control function (PCF) and AMF according to one example embodiment;

FIG. 6 is a network message diagram illustrating a second option for idle mode handling of service level signal control via a PCF and AMF according to one example embodiment;

FIG. 7 is a network message diagram illustrating a third option for idle mode handling of service level signal control via a PCF and a session management function (SMF) according to one example embodiment;

FIG. 8 is a network message diagram illustrating a fourth option for idle mode handling of service level signal control via a PCF and a session management function (SMF) according to one example embodiment;

FIG. 9 is a flow diagram illustrating a method implemented by a WTRU for service level authorization and configuration according to a first example embodiment;

FIG. 10 is a flow diagram illustrating a method implemented by a node including an AMF for service level authorization and configuration according to the first embodiment; and

FIG. 11 is a flow diagram illustrating a method implemented by a WTRU in idle mode for service level authorization and configuration according to an example embodiment.

### DETAILED DESCRIPTION

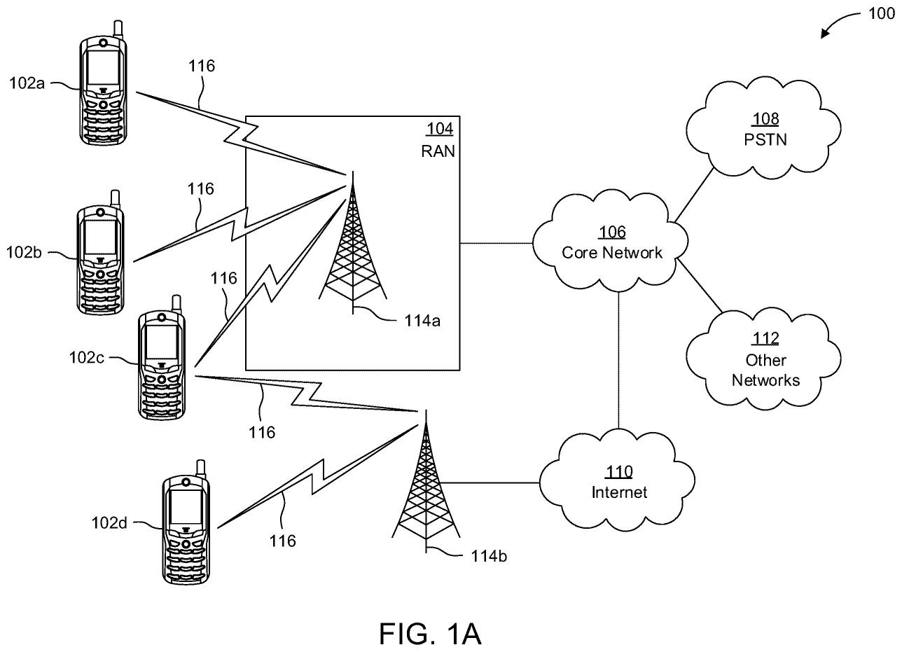

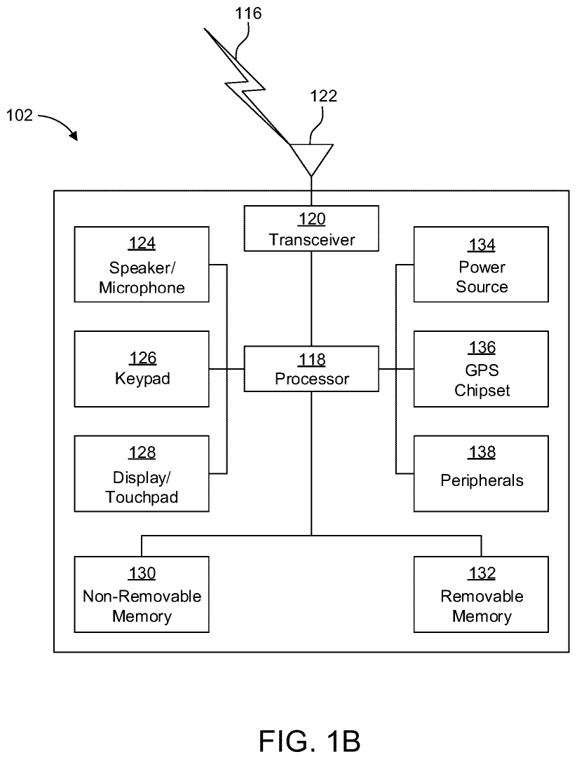

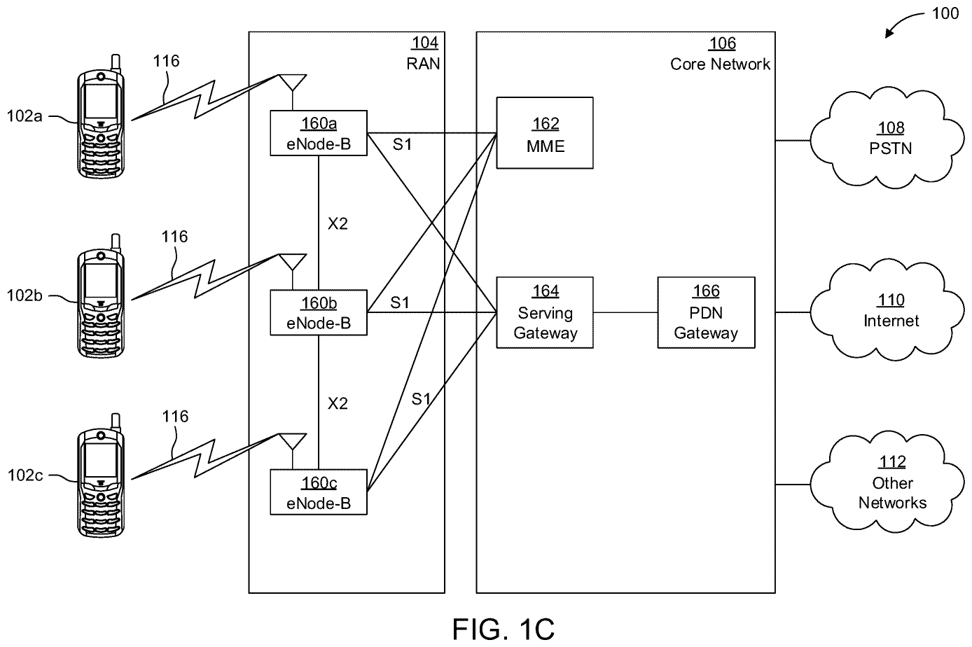

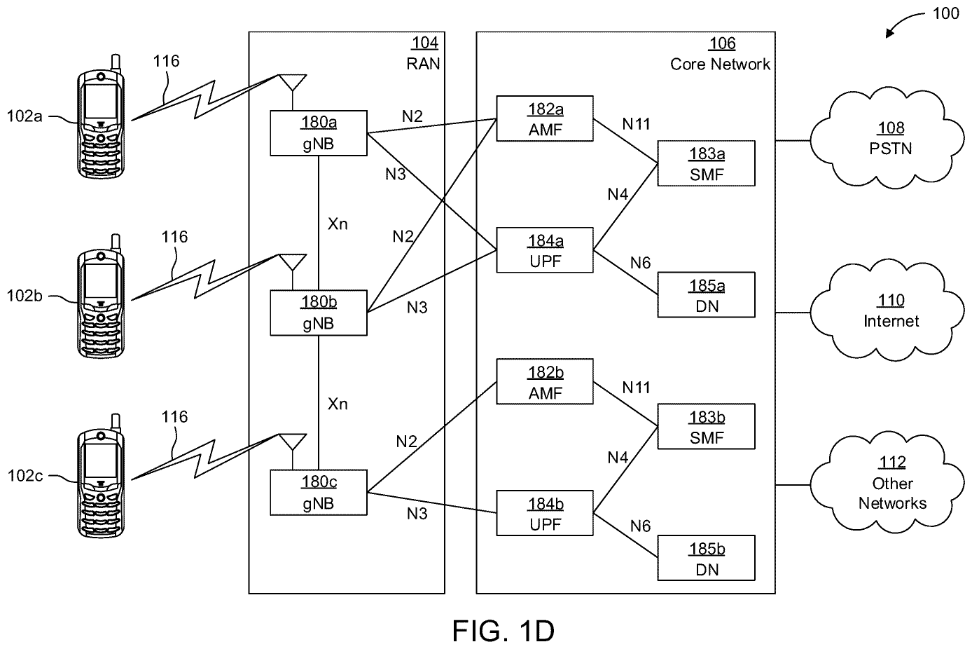

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) nodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 ; 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane (CP) function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes (UPs) during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards user plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

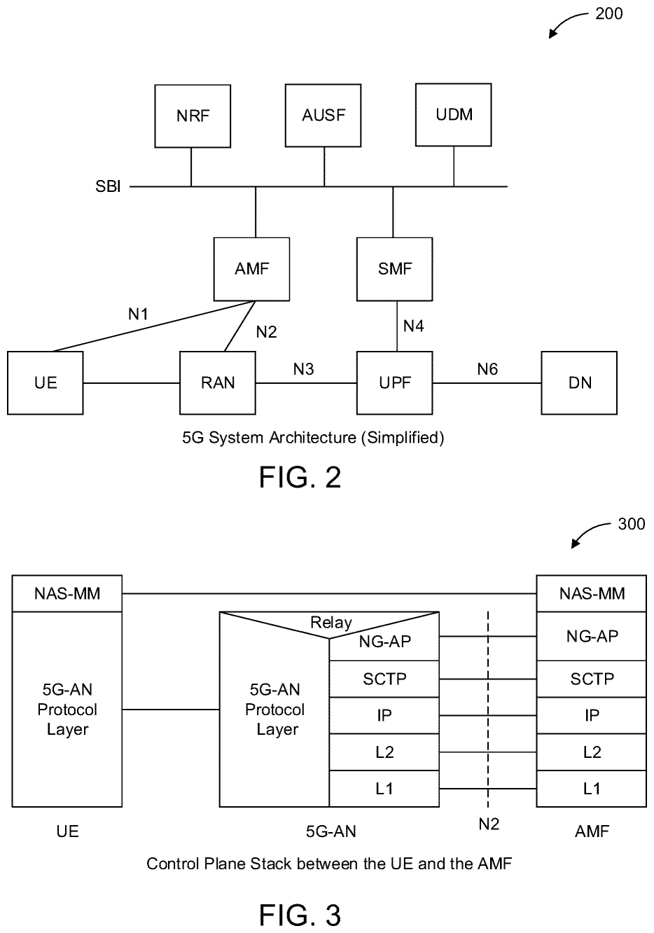

Referring to FIG. 2, a simplified diagram of the 5GS architecture 200 is shown where only a subset of the network functions (NFs) in the 5GC are represented. The NFs (e.g., AMF, SMF, UDM) communicate with each other using the Service Based Interface (SBI) (e.g., using protocols like HTTP). The goal of the Service Base Architecture (SBA) is to enable NFs to expose services (e.g., using RESTful APIs) to other NFs, for the system to provide the desired functionality.

The other interfaces shown (Nx) in FIG. 2, and described below, are different from the SBI. A WTRU communicates with the AMF over N1 using a NAS protocol. Control plane messaging between the WTRU and other NFs (e.g., SMF) is done using NAS transport encapsulation mechanism provided by the AMF for the NFs.

Referring to FIG. 3, the control plane stack 300 between the WTRU and the AMF is shown. The RAN communicates with the AMF over N2 using an NGAP protocol. Control plane messaging between the WTRU and the RAN (Access Stratum (AS)) is done using radio resource control (RRC) (i.e., the top of the 5G-AN protocol layers) which is used to transport NAS messages received or sent by the RAN over N2. 5G Proximity-based Services (ProSe) are services that can be provided by the 5G system to the WTRUs being in proximity to each other. 5G ProSe have functionalities such as 5G ProSe Direct Discovery, 5G ProSe Direct Communication, 5G ProSe UE-to-Network Relay and 5G ProSe UE-to-UE Relay. Once a WTRU is authorized for ProSe service, the WTRU is configured with parameters for ProSe service via NAS connectivity or via dedicated network function (NF) so called 5G Direct Discovery Name Management Function (5G DDNMF). The 5G DDNMF is the logical function handling network related actions required for dynamic 5G ProSe Direct Discovery. When a WTRU is configured with parameters for ProSe Service via NAS connectivity, the WTRU configuration update procedure is used for transparent WTRU policy delivery.

A WTRU configuration update procedure is also utilized for updating other WTRU policy information from the policy and charging control function (PCF). (e.g., Access Network Discovery & Selection Policy (ANDSP), UE Route Selection Policy (URSP), V2X Policy(V2XP), Ranging/Sidelink Position Policy(RSLPP), A2X Policy(A2XP)).

The Next Generation Network architecture is expected to continue and push further the shift started in 5G to embrace a cloud native implementation in the Core Network. The push to bring core network user plane and other functions always closer to the edge will continue to be motivated by the need to support ever increasing traffic levels and lower latencies (e.g., extended reality (XR), meta-verse, artificial intelligence/machine learning (AIML)). With this major trend the possibility to extend SBA to the RAN emerges to simplify the network architecture while taking advantage of cloud native and micro-services architectures capabilities (e.g., scalability, elasticity, open interfaces).

For example, new architecture proposals are emerging with the possibility to extend the SBI framework beyond the 5GC NFs. For example, a WTRU may use an evolved NAS mechanism to exchange NAS messages directly with one or more NFs. As an example, an SBI compliant WTRU may establish an application layer communication directly with an NF (e.g., SMF) without going through the AMF (i.e., instead of via N1).

In another trend, the next generation network is touted as bringing about the so called “connected intelligence” where intelligent networks using AIML technology will be able to connect a multitude of “intelligent” things. With huge amount of data collection from a multitude of devices (e.g., sensors, Ambient IoT) and with the added high flexibility and adaptability of AIML enabled functionalities, the system will pave the way for new advanced applications such as XR/Metaverse.

As mentioned earlier, as the mobile network evolves, there has been a large effort to enable vertical services of the mobile network as value added service for mobile operators. At first IoT service enablement using low cost mobile terminals were developed and later, expanded to value added services using more functionality in a mobile terminal such as Proximity Service (ProSe), Ranging, UAV, etc. As the number of vertical services enabled over 5G network increases, it becomes important for the mobile network to control vertical service enablement efficiently, which will include how WTRUs are authorized and configured with parameters for the vertical services. Until the 5G system (5GS), for each service, parameter configurations have been handled separately via the NAS (control plane signaling) or via user plane (UP) connection in 5G. It will be more beneficial to deploy a general functionality for the configuration and control for service enablement as more vertical services are deployed with the mobile system evolution.

In the 5GS, the WTRU configuration update procedure over NAS connection (i.e. control plane signaling via the WTRU and the AMF connection) are designed to serve this purpose (e.g. for configuring ProSe service, Ranging service, etc.). However, it will not be extensible to use the control plane for vertical service enablement because NAS signaling can be easily overloaded with a single contact point between the WTRU and mobile network, i.e., the AMF is the NAS control plane signaling anchor at the 5GC. For Roaming scenarios, some of the services should be configured directly by the WTRU home network, while other services may be configured by the visited network. Therefore, supporting a roaming situation properly will be also important requirement for service enabling. When the WTRU is configured for many vertical services over a mobile network, solutions are desired for how it may be efficiently configured for different services, regardless of a WTRU's status (e.g. roaming, etc.) and taking into consideration the WTRU's state, i.e. idle vs connected mode.

In various example embodiments, service configuration and relevant parameters are provided over a PDU session dedicated for the service configuration. Over the service configuration PDU session, the WTRU may access a service agent which is responsible for configuration of parameters for the authorized services.

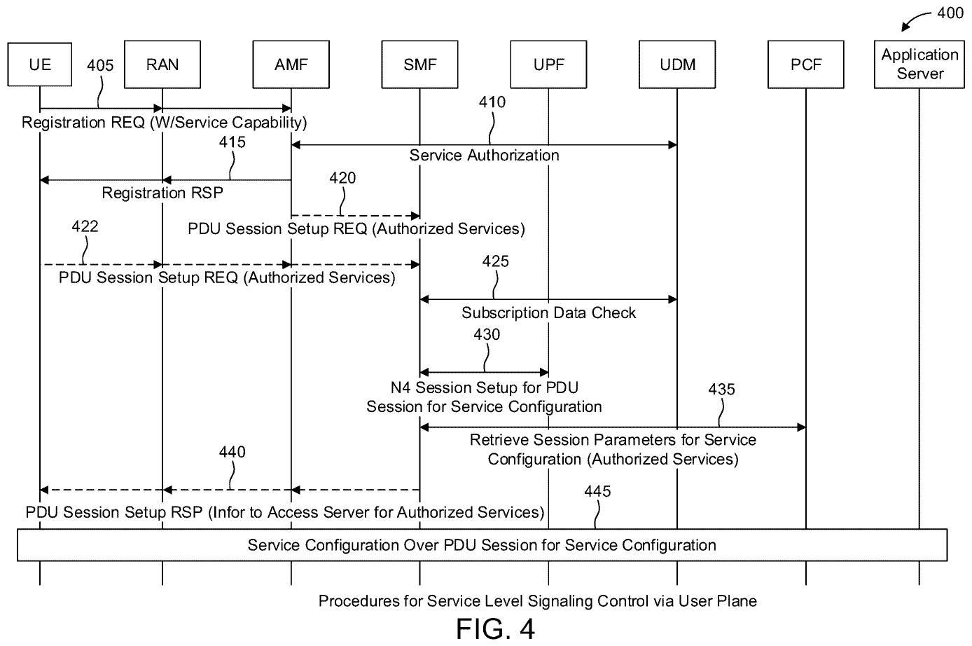

Referring to FIG. 4, a network messaging diagram detailing a method 400 for service level signaling control via the user plane (UP) is shown according to a first example embodiment. At step 405, the WTRU may send a registration request (REQ) to the NW. The registration request may include the WTRU's capability for each service (e.g., a list of supported services such as ProSe, ranging, sensing, artificial intelligence/machine learning (AIML), etc.).

At step 410, after receiving registration request, the AMF may check subscription data from unified data management (UDM) for authorization of service in the WTRU's capability. In step 415, the AMF may send a registration response to the WTRU when the WTRU is successfully registered. The message may include an indication of the authorized services. The message may also include an indication that the establishment of a (e.g., default, network service configuration dedicated) PDU session is pending or not.

At step 420, based on the subscription data from UDM on the authorized service, the AMF may decide to setup a default PDU session for service configuration, unless there is already a PDU session for service configuration established. The AMF may send a PDU session setup request for an authorized service configuration (it has been authorized in step 410). Based on pre-configuration or queried information from UDM, the AMF may indicate a data network name (DNN) dedicated for the service configuration PDU session and any default parameters.

In another embodiment, in step 422, WTRU may send a PDU session setup request for authorized service configuration for the authorized service received in step 415. It is assumed that the WTRU is preconfigured with a DNN dedicated for the service configuration PDU session. After receiving an RRC message including PDU session setup request from the WTRU, the RAN node may send the PDU session setup request to the AMF and the AMF may send a PDU session setup request to the proper SMF, or the RAN node may send the PDU session setup request to the SMF directly, if the RAN node and the SMF may communicate directly.

In step 425, after receiving the PDU session setup request in step 420 or step 422, the SMF may check the subscription data from unified data management (UDM) for the WTRU's authorized services and other parameters (e.g., information for accessing server for authorized services, security credentials for authorized services, etc.), if needed. Here, UDM may include the list of authorized service for each WTRU as part of a subscription data check.

At step 430, after the subscription data check, the SMF may initiate a user plane setup between the RAN and the UPF. The SMF may indicate user plane resource setup to the UPF for handling traffic for authorized service configuration. The SMF may configure the UPF for the PDU session such as to restrict uplink (UL) traffic from the WTRU towards the authorized service(s) configuration endpoint(s).

At step 435, the SMF may retrieve session management parameters from the PCF for service configuration PDU session setup and information to the WTRU for accessing a service configuration server for the authorized services. (for example, the configuration server's address, security credential for accessing per authorized service, configuration version number for each service, etc.)

As another embodiment, step 425 may be performed after step 430. (for example, when different QoS flows are assigned for each authorized service.)

As another embodiment, there may be a Network Function managing security credentials and associated parameters (e.g., nonce, credential version number, initial Vector, etc.) for authorized services for each WTRU. In this case the SMF may communicate with the Network Function to retrieve any security credentials and associated parameters for the WTRU's authorized services.

In step 440, the SMF may send a PDU session setup response (RSP) to the WTRU. When the PDU session setup request (REQ) is received from the AMF in step 420, a PDU session setup response may be sent to the AMF and the AMF may provide the PDU session setup response to the WTRU via NAS transport signaling.

When the PDU session setup REQ is received from the AMF or from the RAN node in step 422, a PDU session setup response may be sent to the AMF or the RAN node and may be delivered to the WTRU.

The PDU session setup response may include information accessing configuration server for the authorized services (for example, configuration server's address, security credential and associated parameters for accessing per authorized service, configuration version number for each service, etc.). The message may include information about the network service configuration dedicated PDU session (e.g., PDU session ID as assigned/reserved by the network, single network slice selection assistance information (S-NSSAI), data network name (DNN) combination. The WTRU may be configured with UE route selection policy (URSP) rules that select this dedicated PDU session for reaching the network service configuration server.

During step 440, after receiving PDU session setup response from SMF, RAN may communicate with the SMF to update its tunnel information for UP connection between RAN and UPF for service configuration PDU session. (e.g., tunnel ID assigned for the PDU session, etc.)

In step 445, the WTRU may receive the service configuration over the service configuration PDU session. When receiving the configuration information, a configuration version number for the configuration information per service is received also and stored in the WTRU. The WTRU may use the security credential and associated parameters received in step 445 to validate the WTRU for the authorized services with application server.

After receiving PDU session setup response in step 440, the WTRU may determine whether to update a configuration parameter for the authorized service based on received configuration version number (e.g., when the received configuration version number is greater than the version number of saved configuration for the service in the WTRU, etc.)

### Configuration Update by Application Server

For a service, if configuration update is needed, application server may inform this to the Network functions in the core network (e.g. to PCF with configuration version number for the service which configuration update is needed.)

When receiving indication for configuration update, PCF may inform SMF of this updated information when SMF tries to retrieve session management parameters for service configuration PDU session setup.

The PDU session for service configuration may be established as an always-on PDU session (e.g., the tunnel between the RAN and UPF is maintained.) While the PDU session is managed, the WTRU and configuration server may manage the connection and if there is any update needed, the configuration server may indicate it as application layer signaling so that the WTRU may download an updated configuration for each service.

If the PDU session is established as always-on PDU session, and the WTRU is not reachable by the configuration server, the configuration server may send an indication for update to the PCF and the indication may be sent to the RAN node (e.g., via the SMF and/or the AMF). When RAN node receives an indication for configuration update, the RAN node may send a RAN level paging if the WTRU has no bearer for communication with the RAN node (e.g., any dedicated bearer or shared bearer), send the indication to the WTRU using a dedicated bearer, or send the indication over any common bearer.

If the PDU session is established and deactivated, when there is any update is needed, solution 6.4 or solution 6.5 may be used for updating the service configuration.

### Roaming Support

There may be some services which shall be configured by application server through home PLMN. For these services, the WTRU may be configured by the NW during registration at HPLMN (e.g., PDU session response for service configuration which is sent by the SMF in HPLMN may include this configuration).

When the WTRU is aware of a service which shall be configured via the HPLMN and the WTRU is assigned a PDU session for service configuration at the VPLMN for the authorized services, the WTRU may access the configuration server at HPLMN via PDU session assigned at the VPLMN using the server access information received from the HPLMN (e.g., address of the configuration server at the HPLMN, the security credential for the authorized service at the HPLMN, etc.)

As another embodiment, when the WTRU accesses the configuration server at the VPLMN (via a PDU session assigned at the VPLMN), the WTRU may request a connection to the server in the HPLMN using the authorized service information, a security credential and an HPLMN information ID. Using this service information, security credential, configuration server may communicate with the configuration server at HPLMN to retrieve the service configuration information.

While downloading service configuration information from the HPLMN via an application server at the VPLMN, the configuration information may be protected using the security material shared between the WTRU and the configuration server at the HPLMN. (e.g., the WTRU may derive the security material to decrypt protected information using security credentials shared when the WTRU is registered at the HPLMN.)

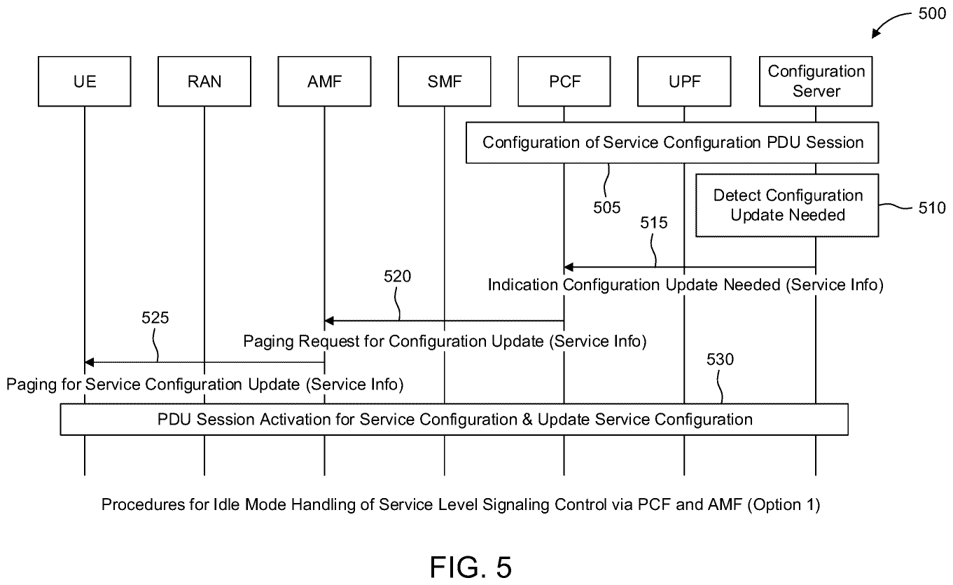

Referring to FIG. 5, a method 500 for idle mode handling of service level signaling connection via the PCF and AMF is shown according to a first embodiment (Option 1). At step 505, the PCF and configuration server communicate to update configuration information for a network service PDU session. At step 510, the configuration server detects the configuration shall be update for a service (e.g., triggered by application server for the service, triggered by 3rd party service provider, etc.). At step 515, the configuration server indicates to the PCF (e.g., directly or via a network exposure function (NEF) not shown) the configuration of a service should be updated. The indication may include the service information and an updated configuration version number of the service. Additionally, the indication may include a list of the WTRU's that may need to be updated. (for example, the WTRU's list subscribed/authorized at the service, the WTRU's list for some specific service area for example when the service is available for some service area, the WTRU's list does not respond to the request from configuration server, the WTRU's list assumed not to be connected state, etc.).

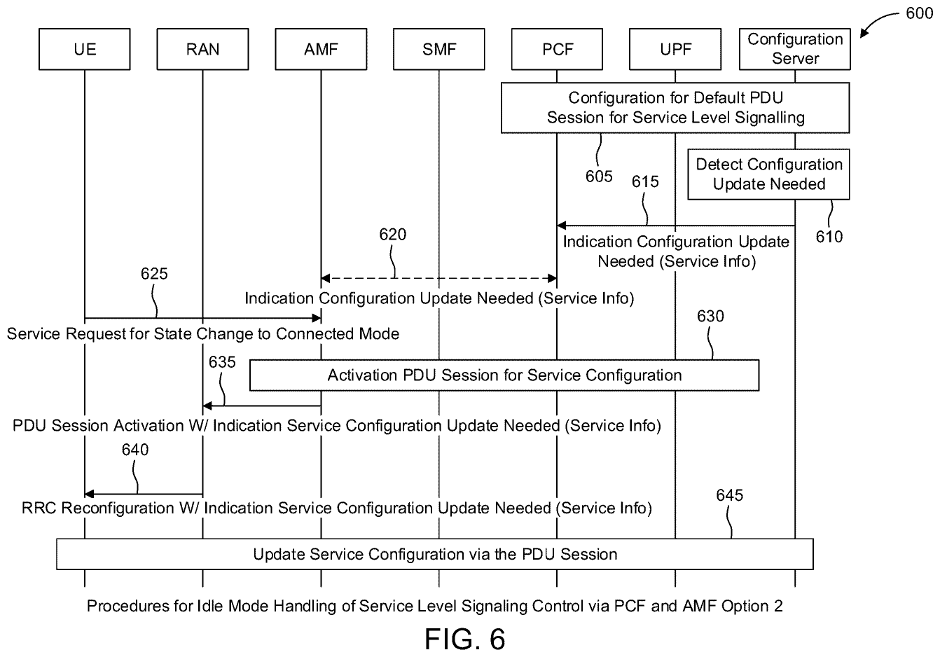

After step 515, as option 1, steps 520-530 may be performed. It is noted that subsequently described embodiments, e.g., options 2-4 in FIGS. 6-8, may use a similar process for steps 505-515 in FIG. 5 and thus their explicit description is omitted for sake of brevity.

At step 520, after receiving indication for configuration update with service information, the PCF may send a paging request for configuration update to the AMF. The paging request may include service information which needs configuration updates or may include a list of WTRUs as received in step 515.

At step 525, after receiving the indication in step 520, the AMF may perform a paging procedure to ask the WTRUs authorized/subscribed for the service, to transit from an idle state to a connected state for updating the service configuration. In certain embodiments, the paging message may include a paging ID for each WTRU as received in step 515.

As another example embodiment, there may be a paging ID dedicated for the service configuration or per service which needs a configuration update via a service configuration PDU session. In this case, the AMF sends the paging message including this dedicated paging ID. WTRUs may receive the paging ID information while the WTRU receives a registration response including the authorized service information, while the WTRU receives a PDU session setup response for the service configuration PDU session, or while the WTRU communicates with the configuration server for configuration update of the authorized service.

At step 530, after receiving paging for the configuration update of the service (e.g. based on dedicated paging for the service configuration or per service, or based on the paging ID dedicated for the WTRU), the WTRU sets up the PDU session for the configuration update if the PDU session is not established or the WTRU activates the PDU session for the configuration update. Additionally, the WTRU communicates with configuration server to update the configuration information for the service.

Referring to FIG. 6, a method 600 for idle mode handling of service level signaling connection via the PCF and AMF is shown according to a second embodiment (Option 2). As mentioned previously, steps 605-615 may be similar to FIG. 5 steps 505-515 and thus their description is omitted. In Option 2, step 620~step 645 may be performed.

At step 620, after receiving indication that a configuration update is needed for some service information from configuration server at step 615, the PCF may send an indication for configuration update of a service. The indication may include the service information and configuration version number of the service.

In step 625 the AMF may receive a request from a WTRU for the state change from idle mode to connected mode and the AMF may verify whether the WTRU is authorized for a service which needs a configuration update (e.g., based on checking UDM with authorized service, based on stored context during registration phase, based on a stored PDU session list associated to the WTRU, etc.)

In step 630, after detecting WTRU is authorized for a service for configuration update, the AMF may communicate with the SMF for activation of the PDU session for the service configuration. In step 635, the AMF may send a PDU session activation request to the RAN with an indication that a service configuration update may be needed, along with associated service information. Additionally, the configuration version number of the service may be included.

At step 640, after receiving the PDU session activation request from the AMF at step 635, the RAN may send a RRC reconfiguration request for activating resource relating for the PDU session service configuration with service information which needs configuration update. Additionally, the configuration version number of the service may be included. At step 645, after receiving an RRC reconfiguration update with service information for configuration update, the WTRU may connect to the configuration server via the service configuration PDU session. The WTRU may determine whether to update configuration parameter for the authorized service based on received configuration version number (e.g., when the received configuration version number is greater than the version number of saved configuration for the service in the WTRU, etc.).

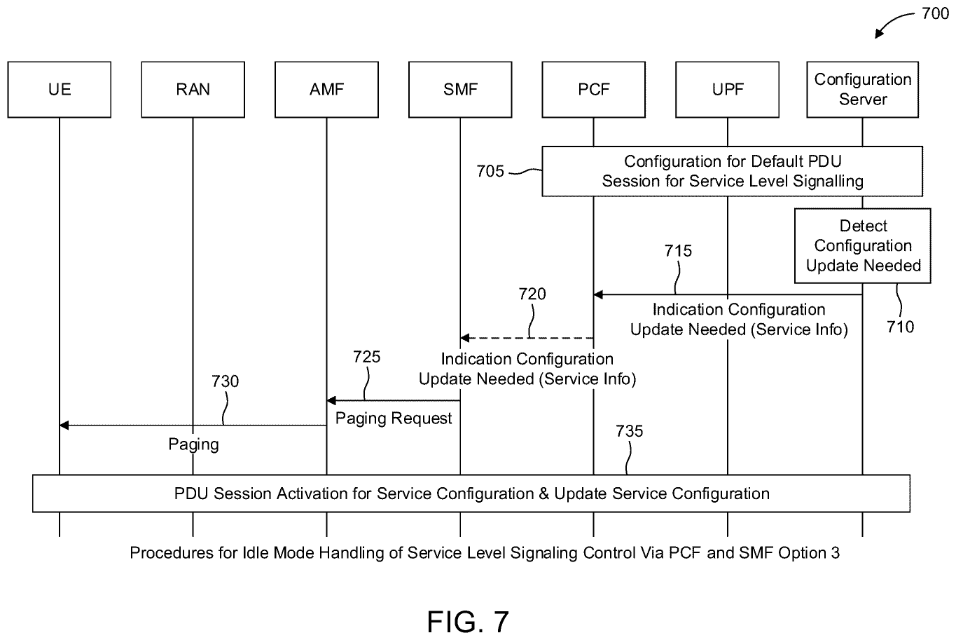

Referring to FIG. 7, a method 700 for idle mode handling of service level signaling connection via the PCF and SMF is shown according to a third example embodiment (Option 3). Method 700 differs from the previously described Options 1 and 2 embodiments based on SMF and PCF interactions, rather than AMF and PCF actions. In method 700 step 705, the PCF and configuration server communicate to update configuration information for the network service as in previous embodiments. Also, as in previous embodiments, the configuration server detects 710 the configuration should be updated for a service (e.g., triggered by application server for the service, triggered by 3rd party service provider, etc.). and indicates 715 to the PCF the configuration of a service should be updated. The indication may include the service information and updated configuration version number of the service. Additionally, the indication may include list of WTRU's needs to be updated. (for example, the WTRU's list subscribed/authorized at the service, the WTRU's list for some specific service area for example when the service is available for some service area, the WTRU's list not responding to the request from configuration server, the WTRU's list assumed not to be connected state, etc.)

At step 720, after receiving indication for configuration update with service information, the PCF may send the SMF, which is responsible for the service configuration PDU session, an indication for configuration update of a network service. The indication may include the service information and configuration version number of the service. After receiving the indication, the SMF may send 725 a paging request to the AMF. The SMF may include service information for which a configuration update needed. The SMF may include a list of WTRUs to be paged for the service configuration update of the service and the SMF may include a configuration version number of the service. Based on the paging request from the SMF, the AMF performs 730 a paging procedure to ask WTRUs authorized/subscribed for the service, to transit from the idle state to the connected state for update of their service configuration. In an example, the paging message may include a paging ID for each WTRU received from the SMF in step 725.

As another embodiment, there may be a paging ID dedicated for the service configuration or per service which needs configuration update via the service configuration PDU session. In this case, at step 730, the AMF sends a paging message including this dedicated paging ID. WTRUs may know the paging ID information from receiving a registration response including the authorized service information, a PDU session setup response for the service configuration PDU session, or based on the configuration server for a configuration update of the authorized service.

After receiving the paging for the configuration update of the service (e.g. based on dedicated paging ID for the service configuration or per service or based on paging ID dedicated for the WTRU), at step 735 the WTRU sets up the PDU session for a configuration update if the PDU session is not established or the WTRU activates the PDU session for the configuration update if the PDU session is already established. Additionally, at step 735, the WTRU may communicate with the configuration server to update the configuration information for the service.

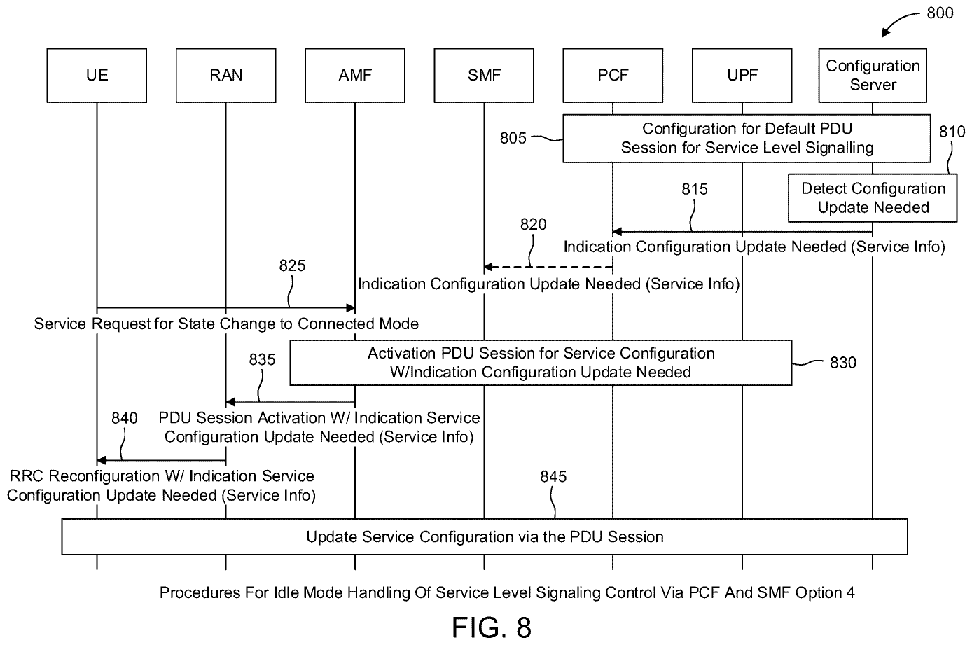

Referring to FIG. 8, a method 800 for idle mode handling of service level signaling connection via the PCF and SMF is shown according to a fourth example embodiment (Option 4). By way of example, after step 815, as Option 4, step 820~step 845 may be performed. After receiving indication for configuration update needed for some service information from configuration server at step 815, the PCF may send 820 the SMF an indication for a configuration update of a service. As an example, the indication may include the service information and configuration version number of the service.

In step 825, the AMF may receive a service request from a WTRU for the state change from idle mode to connected mode. At step 830, the AMF may communicate with the SMF for activation of the PDU session for service configuration. The SMF may inform the AMF that the PDU session for service configuration should be activated for configuration update for a service.

In one example, the AMF may receive an indication for configuration update of a service, which may include the service information and configuration version number of the service from the SMF. Based on received indication from SMF, after receiving a service request at step 825, the AMF may verify whether the WTRU is authorized for a service which needs configuration update (e.g., based on checking UDM with authorized service, based on stored context during the registration phase, based on a stored PDU session list associated to the WTRU, etc.). After successful verification of the WTRU, the AMF may communicate with SMF for activation of the PDU session at step 830.

At step 835, the AMF may send a PDU session activation request to the RAN with indication service configuration update needed with associated service information. Additionally, configuration version number of the service may be included. After receiving the PDU session activation request from the AMF, at step 840 the RAN may send a RRC reconfiguration request for activating resources relating to the PDU session service configuration with service information which may require a configuration update. Additionally, a configuration version number of the service may be included. After receiving RRC reconfiguration update with service information for configuration update, at step 845, the WTRU may connect to the configuration server via the service configuration PDU session.

Examples of management of a service configuration PDU session are now described. When the WTRU is authorized services and setup a PDU session for those authorized services, separate QoS flows may be assigned for each authorized service. When WTRU is assigned separate QoS flow for each authorized service, based on status update of services, PDU session modification may be performed. For example, if WTRU is authorized an additional service, a PDU session modification procedure may be triggered from the WTRU or the network to add a QoS flow for the newly authorized service. In another example, if WTRU is rejected/unsubscribed for a service, a PDU session modification procedure may be triggered to delete QoS flow for the service.

In various embodiments, the AMF or the SMF may detect the updated authorized service information (e.g., by comparing authorized service information from UDM and QoS flow information in the established PDU session for service configuration. Once the SMF or the AMF detects there is mismatch on the allowed QoS flows for services in the PDU session and the authorized service list, a PDU session modification procedure may be initiated by the SMF or the AMF. Additionally, the PDU session modification request signaling may be sent to the WTRU.

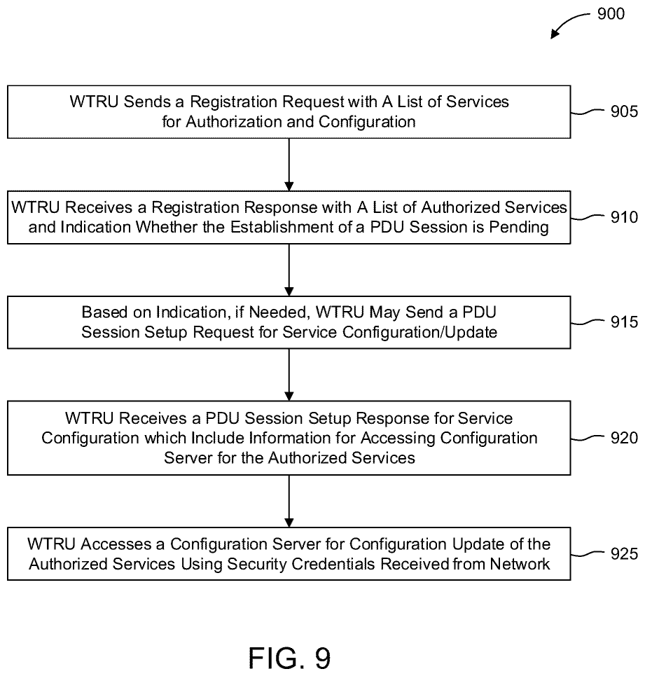

Referring to FIG. 9 a method 900 implemented by a WTRU using service level signaling control via the user plane is shown and described according to one example embodiment. In method 900, a WTRU sends 905 a registration request with a list of services for authorization and configuration. The WTRU receives 910 a registration response with a list of authorized services and an indication whether the establishment of a PDU session is pending, e.g., a dedicated PDU session for service configuration updates.

At step 915, based on the indication, if needed, a WTRU may send a PDU session setup request for service configuration. The WTRU receives 920 a PDU session setup response for service configuration which includes information for accessing a configuration server for the authorized services. The WTRU accesses the configuration server, via the information from the PDU session, for a configuration update of the authorized service(s) using security credentials received from network. Although not shown, the configuration update is retrieved and implemented by the WTRU.

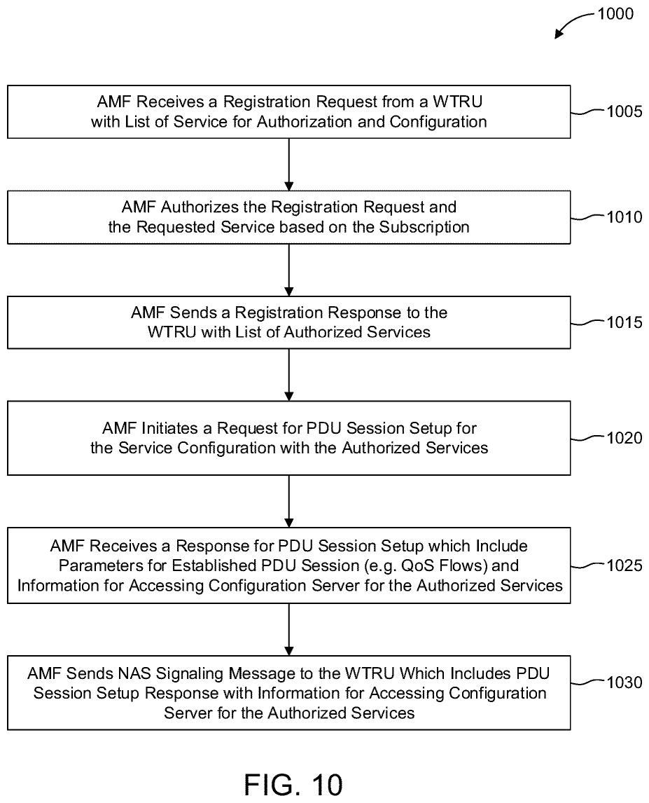

Referring to FIG. 10, a method 1000 for a network node implementing an AMF using service level signaling control via the user plane is shown and described according to an example embodiment. The AMF receives 1005 a registration request from a WTRU with a list of service for authorization and configuration. The AMF authorizes 1010 the registration request and the requested service(s) based on the subscription data of the WTRU from UDM.

The AMF sends 1015 a registration response to the WTRU with a list of authorized service(s) and initiates 1020 a request for PDU session setup for the service configuration with the authorized service(s). Next, the AMF receives 1025 a response for PDU session setup which includes parameters for establishing a service configuration PDU session (e.g. QoS flows) and information for accessing configuration server for the authorized services. The AMF may send 1030 send a NAS signalling message to the WTRU which include PDU session setup response with information for accessing configuration server for the authorized services.

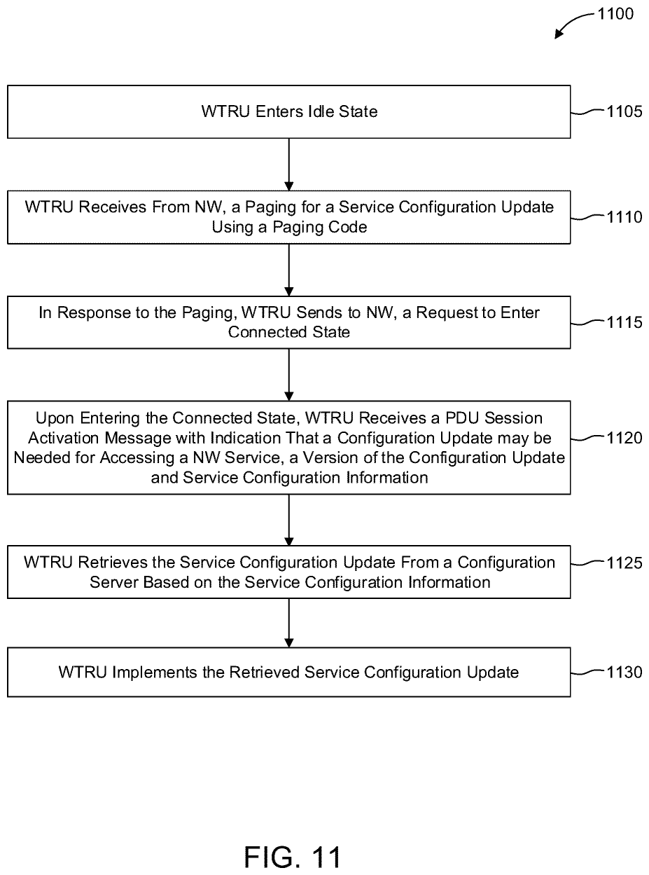

Referring to FIG. 11, a method 1100 implemented in a WTRU for idle mode handling of service level signaling is shown and described according to an example embodiment. Initially, the WTRU enters 1105 an idle state. The WTRU receives 1110 a paging for a service configuration update using paging code assigned for service configuration update indication, for service information, or for WTRU information. In response to the paging, the WTRU sends 1115 a service request for a state change from the idle state to the connected state. Upon entering the connected state, the WTRU receives 1120, a PDU session activation with indication of a service configuration update with relevant service information. The indication may also include a version of the configuration update. The WTRU may also determine it should obtain the service configuration update based on configuration version number per service. Next, the WTRU retrieves 1125 the service configuration update from a configuration server based on the indicated service configuration information. Lastly, the WTRU may implement 1130 the retrieve service configuration update to be able to use the authorized service.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a wireless transmit/receive unit (WTRU), the method comprising:
sending, to a network, a registration request including an indication of WTRU capability to support one or more network services requiring authorization for use;
receiving, from the network, a registration response with an indication of an authorized service for the WTRU;
receiving, from the network, information for accessing a configuration server for the authorized service; and
based on the received information for accessing the configuration server, accessing the configuration server via a protocol data unit (PDU) session, to retrieve a configuration update for use of the authorized service.

2. The method of claim 1, wherein the registration response further includes an indication that establishment of the PDU session is not pending for the authorized service, and the method further comprises:
based on the indication the establishment of the PDU session is not pending and the indication of the authorized service, sending, to the network, a PDU session setup request for configuration of the authorized service, and
receiving a PDU session establishment accept response including the information for accessing the configuration server.

3. The method of claim 2, wherein the PDU session establishment accept response is received via non-access stratum (NAS) signaling.

4. The method of claim 1, wherein the registration response further includes an indication that establishment of the PDU session is pending for the authorized service based on a dedicated network service configuration PDU session.

5. The method of claim 1, wherein the authorized service comprises one of proximity services (ProSe), ranging, sensing or artificial intelligence machine learning (AIML) services.

6. The method of claim 1, wherein the information for accessing the configuration server includes one or more of a configuration server address, a security credential and associated parameters for accessing the authorized service or a configuration version number for the authorized service.

7. A wireless transmit/receive unit (WTRU) comprising:
a transceiver; and
a processor communicatively coupled to the transceiver, wherein the transceiver and the processor are configured to:
send, to a network, a registration request including an indication of WTRU capability to support one or more network services requiring authorization for use;
receive, from the network, a registration response with an indication of an authorized service for the WTRU;
receive, from the network, information for accessing a configuration server for the authorized service; and
based on the received information for accessing the configuration server, access the configuration server via a protocol data unit (PDU) session, to retrieve a configuration update for use of the authorized service.

8. The WTRU of claim 7, wherein the registration response further includes an indication that establishment of the PDU session is pending for the authorized service, and wherein the transceiver and the processor are further configured to:
based on the indication the establishment of the PDU session is not pending and the indication of the authorized service, send, to the network, a PDU session setup request for configuration of the authorized service, and
receive a PDU session establishment accept response including the information for accessing the configuration server.

9. The WTRU of claim 8, wherein the PDU session establishment accept response is received via non-access stratum (NAS) signaling.

10. The WTRU of claim 7, wherein the registration response further includes an indication that establishment of the PDU session is pending for the authorized service based on a dedicated network service configuration PDU session.

11. The WTRU of claim 7, wherein the authorized service comprises one of proximity services (ProSe), ranging, sensing or artificial intelligence machine learning (AIML) services.

12. The WTRU of claim 7, wherein the information for accessing the configuration server includes one or more of a configuration server address, a security credential and associated parameters for accessing the authorized service or a configuration version number for the authorized service.

13. A method implemented by a wireless transmit/receive unit (WTRU), the method comprising:
entering an idle state;
receiving, from a network, a paging for a service configuration update using a paging code;
in response to the paging, sending to the network, a request for the WTRU to enter into a connected state;
upon entering the connected state, receiving from the network, a PDU session activation message with an indication that a configuration update may be needed for accessing a network service, a version of the configuration update and service configuration information;
based on the version of the configuration update, determining to retrieve the configuration update; and
retrieving, from a configuration server based on the determination and the service configuration information, the configuration update for the network service.

14. The method of claim 13, wherein the PDU session activation message directs the WTRU to an always-on PDU session and wherein the configuration update is retrieved through the always-on PDU session.

15. The method of claim 13, wherein the configuration server comprises an application server which initiated the paging through the network.

16. The method of claim 13, wherein the configuration server is associated with a home public land mobile network (H-PLMN) of the WTRU.

17. The method of claim 13, wherein the configuration server is associated with a visiting public land mobile network (V-PLMN).
